(19) United States
(12) Patent Application Publication
(10) Pub. No.: US 2011/0194829 A1
(43) Pub. Date: Aug. 11, 2011

(54) OPTICAL GROUND WIRE CABLE RETENTION BRACKET

(75) Inventors: Rich Cubala, Greer, SC (US); Lou Guzzo, Inman, SC (US)

(73) Assignee: AFL TELECOMMUNICATIONS LLC, Spartanburg, SC (US)

(21) Appl. No.: 12/999,228

(22) PCT Filed: Jul. 16, 2010
(86) PCT No.: PCT/US10/42246

§ 371 Date: Dec. 15, 2010

Related U.S. Application Data
(60) Provisional application No. 61/225,967, filed on Jul. 16, 2009.

(51) Int. Cl. G02B 6/44; B23P 11/00

(52) U.S. Cl. 385/135; 29/428

(57) ABSTRACT

A bracket for mounting an multi-layer cable, such as an optical ground wire, to a fiber optic splice closure, and a method of inserting the multi-layer cable into the fiber optic splice closure using the bracket. The bracket includes mounting holes that are configured to attach to ground studs of the fiber optic splice closure. The bracket also includes cable grip protrusions that align with the entry ports into the fiber optic splice closure. The bracket is attached to the ground studs, and an outer layer of the multi-layer cable is attached to the cable grip protrusions using cable clamps. A portion of the outer layer of the multi-layer cable is removed so that the inner layer can properly enter the entry port into the fiber optic splice closure.

### CROSS-REFERENCE TO RELATED APPLICATIONS

This application claims the benefit of co-pending U.S. Provisional Patent Application No. 61/225,967, filed on Jul. 16, 2009 in the U.S. Patent and Trademark Office, the disclosure of which is incorporated herein in its entirety by reference.

### BACKGROUND OF THE INVENTION

1. Field of the Invention

The present invention relates to a bracket for securing an optical ground wire (OPGW) cable to a fiber optic splice closure.

2. Description of the Related Art

Many fiber optic splice closures are currently in wide use. Existing fiber optic splice closures are configured to secure a specific type of fiber optic cable, such as a black-jacket or plastic sheathed fiber optic cable. The fiber optic splice closures provide a sealed enclosure to protect splices between two fiber optic cables from the surrounding environment. Grommets can be used to create a weather-proof seal at the entry points of the fiber optic cables into the fiber optic splice enclosure.

However, one type of cable that will not work properly with many existing fiber optic splice closures and grommets are OPGW cables. OPGW cables comprise an inner layer and an outer metallic sheath. The outer metallic sheath acts as a grounding cable while the inner layer houses optical fibers. OPGW cables are typically strung above power transmission lines to protect the lower strung power transmission lines from lightning strikes.

The outer metallic sheath usually comprises a plurality of metal grounding strands wrapped around the center tube. The plurality of metal grounding strands creates an irregular shape on the outermost surface of the OPGW cable. Accordingly, the grommets used to seal the entry port into the fiber optic splice closure will not form a water tight seal with the irregularly shaped outer metallic sheath.

A current practice is to seal the spaces between the entry port of the fiber optic closure and the OPGW cables with a curing liquid. This curing liquid, however, can be messy, requires set-up time, depends on the skill of application by the operator in the field, and can degrade over time.

Furthermore, it is possible that a diameter of the entry ports into the fiber optic closure, or a diameter of the grommets, is smaller than the outer diameter of the OPGW cable. Therefore, the OPGW cable may not be able to be used with existing fiber optic splice closures that were designed for use with a smaller diameter cable.

When an OPGW cable is used in combination with a fiber optic splice closure, a specialized procedure is required to securely attach the OPGW cable to the fiber optic splice closure and to provide a water-tight seal around the entry port of the fiber optic splice closure.

Accordingly, there is a need for a simple cable retention bracket and method of securing a cable that allow certain types of cables, such as OPGW cables, to be connected to fiber optic splice closures that are designed for a different type of cable, such as black-jacket and plastic sheathed fiber optic cables.

### SUMMARY OF THE INVENTION

Accordingly, an aspect of the present invention is to provide a cable retention bracket for securing an OPGW cable to a fiber optic splice closure, and a method of securing the OPGW cable to the fiber optic splice closure. The cable retention bracket is used in conjunction with a cable clamp to secure the OPGW cable to the fiber optic splice closure, thereby securing the OPGW cable to a tower for power transmission lines. The tensile, compressive, twisting, and flexing forces that the OPGW cable will experience during its life are isolated on the mounting bracket, and will have minimal effect on the entry of the inner cable into the fiber optic splice closure.

Advantageously, the mounting bracket comprises a mounting plate comprising at least one mounting hole and at least one cable grip protrusion extending transversely with respect to the mounting plate. The at least on cable grip protrusion aligns with an edge of an entry port on the splice closure. The entry port is smaller than an outer layer of the multi-layer cable, but not an inner layer of the multi-layer cable.

Another aspect of the invention is that the at least one mounting hole comprises a first set of mounting holes and that are configured to fit over ground studs on the splice closure such that the mounting bracket can be attached to the splice closure by placing the mounting holes over the ground studs.

Another aspect of the invention is that the at least one cable grip protrusion comprises teeth extending transversely with respect to the cable grip protrusion.

Another aspect of the invention is that the multi-layer cable comprises an outer layer of metallic strands wrapped around a central cable where each individual tooth of the teeth is configured to fit between two adjacent metallic strands.

Another aspect of the invention is that the mounting plate comprises a second set of mounting holes configured to fit over ground studs on a second splice closure such that the mounting bracket can be attached to the second splice closure by placing the mounting holes over the ground studs on the second splice closure.

Another aspect of the invention is that the mounting plate comprises a second cable grip protrusion extending transversely with respect to the mounting plate wherein the second cable grip protrusion aligns with a second edge of a second entry port on a second splice closure and wherein the second entry port is configured to receive an inner layer of the multi-layer cable.

Another aspect of the invention is that the multi-layer cable is an optical ground wire cable.

Another aspect of the invention is that the cable grip protrusion is configured to grip the outer layer of the multi-layer cable outboard of the cable splice closure such that the tensile, compressive, twisting, and flexing forces applied on the multi-layer cable are isolated to the mounting bracket, and will not impact the entry of the inner layer of the multi-layer cable into the fiber optic splice closure.

Another aspect of the invention is that the diameter of the entry port is defined by a hole in the splice closure.

Another aspect of the invention is that the diameter of the entry port is defined by a grommet.

Another aspect of the invention is that the diameter of the outer layer of the multi-layer cable is irregular and the diameter of the inner layer of the multi-layer cable is constant.

Furthermore, the present invention encompasses a method of mounting a multi-layer cable to a splice closure. The method comprises providing a multi-layer cable comprising an outer layer and an inner layer, removing a portion of the outer layer from the multi-layer cable at an end or midsection of the multi-layer cable, thereby exposing the inner layer, and providing a mounting bracket. The mounting bracket comprises a mounting plate comprising at least one mounting hole, at least one cable grip protrusion extending transversely with respect to the mounting plate, wherein the at least one cable grip protrusion aligns with an edge of an entry port on the splice closure, wherein a diameter of the entry port is smaller than a diameter of an outer layer of the multi-layer cable. The method further comprises attaching the mounting bracket to the splice closure using the at least one mounting hole, securing the outer layer of the multi-layer cable to the at least one cable grip protrusion, and inserting the exposed inner layer into the splice closure.

The method further comprises providing the at least one cable grip protrusion with teeth wherein the outer layer of the multi-layer cable is secured to the at least one cable grip protrusion by aligning the multi-layer cable with the teeth and clamping the outer layer of the multi-layer cable against the teeth.

The method further comprises that the multi-layer cable is an optical ground wire.

The method further comprises that the outer layer of the multi-layer cable comprises a plurality of strands wrapped around the inner layer of the multi-layer cable.

### BRIEF DESCRIPTION OF THE DRAWINGS

FIG. 1 is a perspective view of a mounting bracket.

FIG. 2 is a perspective view of a fiber optic splice closure.

FIG. 3 is a bottom view of the mounting bracket attached to the fiber optic splice closure.

FIG. 4 is a perspective view of optical ground wire cables mounted to the mounting bracket which is attached to the fiber optic splice closure.

FIG. 5 is a side view of optical ground wire cables mounted to the mounting bracket which is attached to the fiber optic splice closure.

### DETAILED DESCRIPTION OF THE EXEMPLARY EMBODIMENTS

The cable retention bracket according to non-limiting exemplary embodiments of the present invention will now be described more fully with reference to the accompanying drawings.

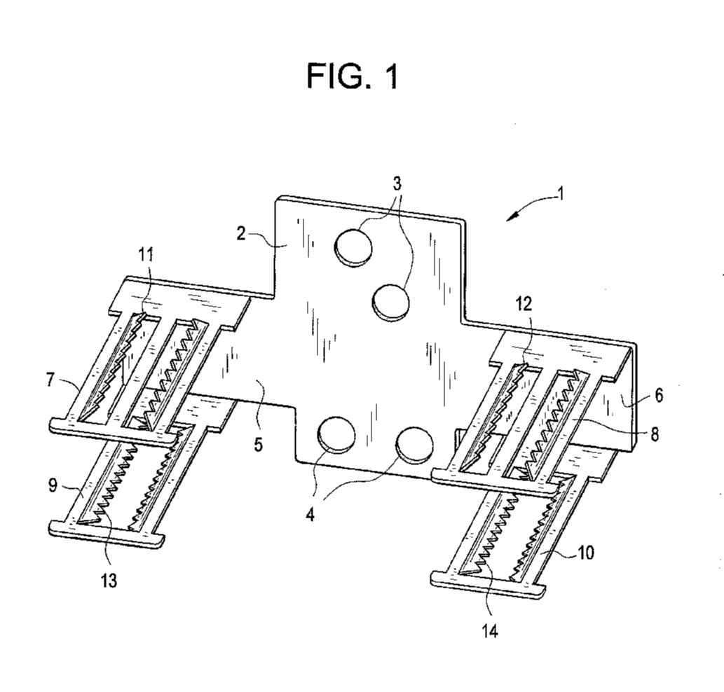

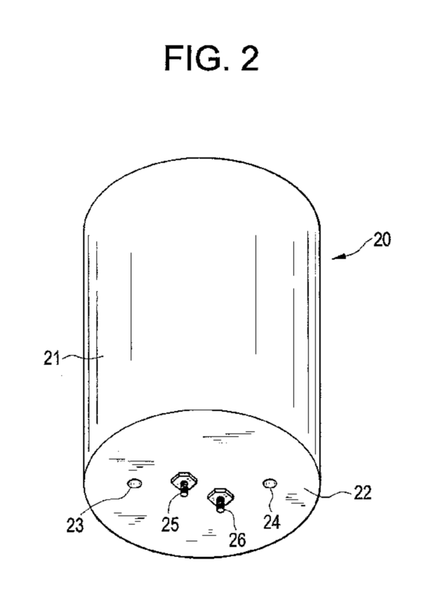

Referring to the exemplary embodiment shown in FIG. 1, a cable retention bracket 1 is shown. The cable retention bracket 1 is preferably made from a high conductivity metal. The cable retention bracket 1 comprises a central mounting plate 2, where the central mounting plate 2 comprises a first set of mounting holes 3 and a second set of mounting holes 4. The first set of mounting holes 3 are configured to fit over ground studs of a first type of fiber optic cable splice closure 20 (see FIG. 2), and the second set of mounting holes 4 are configured to fit over grounding studs of a second type of fiber optic splice closure. It should be recognized that more or less sets of mounting holes can be included on the central mounting bracket 2. Furthermore, a single mounting hole or more than two mounting holes can be used in place of the sets of mounting holes shown in the exemplary embodiments.

Extending from either side of the mounting plate 2 are extensions 5 and 6. The extensions 5, 6 are shown as extending along the same plane as the mounting plate 2, but it is possible for the extensions 5, 6 to extend along a different plane. Extending substantially perpendicularly from the extensions 5, 6 are a first cable grip protrusion 7, a second cable grip protrusion 8, a third cable grip protrusion 9, and a fourth cable grip protrusion 10. Each cable grip protrusion 7, 8, 9, 10 comprises cable grip teeth 11, 12, 13, 14, respectively. The cable grip teeth 11, 12, 13, 14 are aligned in a direction that is substantially parallel with a direction that the cable grip protrusions 7, 8, 9, 10 extend away from the extensions 5, 6. The cable grip teeth 11, 12, 13, 14 prevent the cable from pulling out when the cable is attached to the cable grip protrusions 7, 8, 9, 10. Accordingly, serrations, protrusions, or grit, such as a sandpaper finish, could be used in place of the cable grip teeth. The first cable grip protrusion 7 and the second cable grip protrusion 8 are used to mount cables to the fiber optic splice closure when the first set of mounting holes 3 is mounted to the fiber optic splice closure. The third cable grip protrusion 9 and the fourth cable grip protrusion 10 are used to mount cables to the fiber optic splice closure when the second set of mounting holes 4 is mounted to a second, differently configured, fiber optic splice closure.

The cable retention bracket may include a single cable grip protrusion that mounts a single cable to a fiber optic splice closure. Alternatively, the cable retention bracket may include more than two cable grip protrusions. For example, if the fiber optic splice closure includes four entry ports, a cable retention bracket comprising four cable grip protrusions can be used, provided that the four cable grip protrusions align with the four entry ports when the cable retention bracket is mounted to the fiber optic splice closure.

FIG. 2 shows a first type of fiber optic splice closure 20. The fiber optic splice closure 20 comprises a body 21, in which is configured to house the fiber optic cable splices. A first end 22 of the fiber optic splice closure 20 includes a first entry port 23 and a second entry port 24, into which fiber optic cables enter the fiber optic splice closure 20. The first end also includes two ground studs 25 and 26, for grounding the fiber optic splice closure 20.

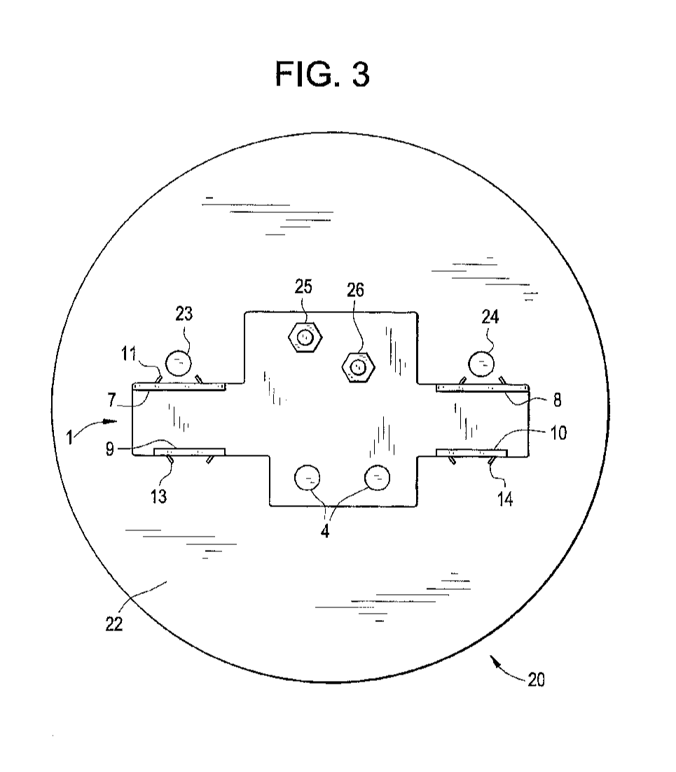

In the embodiment of the cable retention bracket 1 shown in FIG. 1, the first set of mounting holes 3 are positioned to correspond with the positioning of the two ground studs 25 and 26 of the fiber optic splice closure 20 shown in FIG. 2. Furthermore, when the cable retention bracket 1 is mounted on the fiber optic splice enclosure 20, the cable grip protrusions 7 and 8 extend transversely from, and preferably substantially perpendicularly from, the first end 22 and are positioned such that they align with an edge, or near an edge, of the first entry port 23 and the second entry port 24, respectively, as shown in FIG. 3. The cable grip protrusions 9 and 10 are configured to align with an edge, or near an edge, of the entry ports of a differently configured cable splice enclosure.

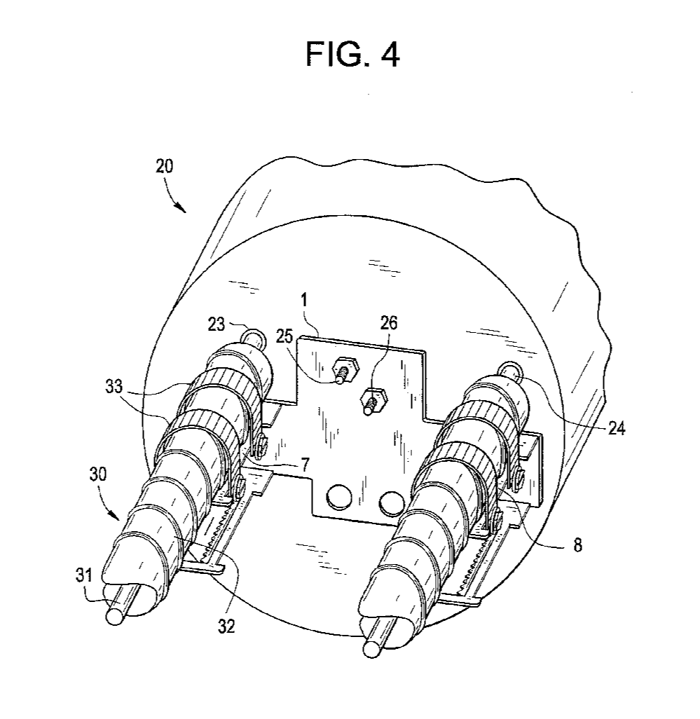

As shown in FIG. 4, the cable retention bracket 1 is mounted to the fiber optic splice closure 20 by placing the mounting holes 3 over the two ground studs 25 and 26, and securing the cable retention bracket 1 to the ground studs using nuts.

The OPGW cable 30 that is used with the cable retention bracket 1 comprises an inner cable 31 carrying at least one fiber optic strand and an outer metallic sheath 32. The outer metallic sheath 32 can comprise a plurality of metallic strands wound around the inner cable 31. Of course, any type of cable comprising an inner layer and an outer layer could be used with the cable retention bracket.

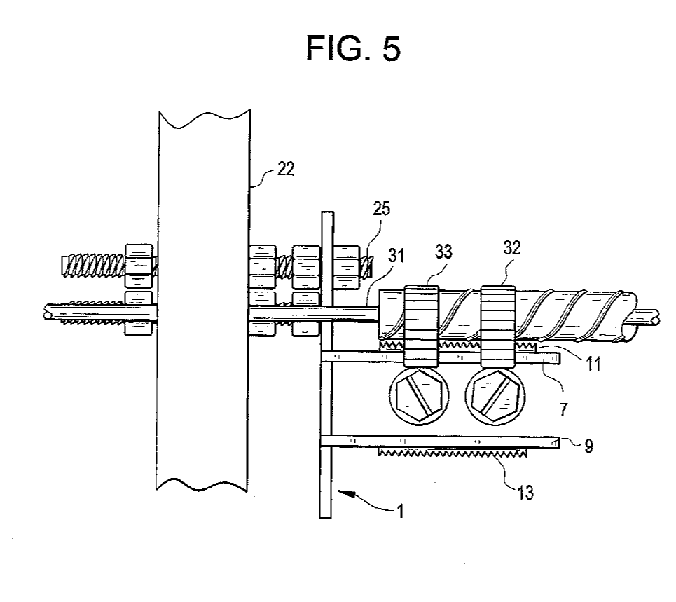

To mount the OGPW cable 30 to the bracket 1, a section of the outer metallic sheath 32 is removed from an end or midsection of the OPGW cable 30, thereby exposing the inner cable 31. The OPGW cable 30 is then aligned with the cable grip teeth 11 and placed against the cable grip teeth 11, such that the cut end of the outer metallic sheath 32 is placed at the end of the cable grip teeth 11 as shown in FIG. 5, or near the end of the cable grip teeth 11. In this manner, the inner cable 31 is aligned with the entry port 23. At least one cable clamp 33 is used to secure the OPGW cable 30 to the cable grip protrusion 7 by wrapping the cable clamp 33 around the OPGW cable 30 and the cable grip protrusion 7. The cable clamp 33 is then tightened such that the OPGW cable 30 is secured tightly against the corresponding cable grip teeth 11. The cable grip teeth 11 are preferably configured such that each individual tooth fits between the space between adjacent strands of the outer metallic sheath 32. The exposed inner cable 31 is then inserted into the entry port 23 of the fiber optic splice closure 20, where the fiber optic cable can then be spliced.

Of course, it can be appreciated that an OPGW cable can be mounted using the cable grip protrusions 8, 9 and 10 in a manner similar to that as described above with respect to the cable grip protrusion 7.

The combination of the cable gripping teeth 11 and the cable clamp 33 creates a tight grip on the outer metallic sheath 32 of the OPGW cable 30, creating a rigid connection between the OPGW cable 30 and the bracket 1. Thus, the tensile, compressive, twisting, and flexing forces that the OPGW cable 30 will experience during its life are isolated on the mounting bracket, and will have minimal effect on the entry of the inner cable 31 into the fiber optic splice closure 20. Furthermore, since the OPGW cable 30 is trimmed outboard of the closure, the fiber optic splice closure 20 can form a watertight seal with the inner cable 31, thereby preventing water ingress into the fiber optic splice closure 20. Furthermore, since the bracket is attached to the ground studs 23 and 24, the outer metallic sheath 32 is adequately grounded.

While this invention has been particularly shown and described with reference to exemplary embodiments thereof, the above description should be considered as illustrations of the exemplary embodiments only and are not for purposes of limitation. Therefore, the scope of the invention is defined not by the detailed description of the invention but by the appended claims, and all differences within the scope will be construed as being included in the present invention.

What is claimed is:

1. A mounting bracket for mounting a multi-layer cable to a splice closure, the mounting bracket comprising:
a mounting plate comprising at least one mounting hole;
at least one cable grip protrusion extending transversely with respect to the mounting plate;
wherein the at least on cable grip protrusion aligns with an edge of an entry port on the splice closure;
wherein a diameter of the entry port is smaller than a diameter of an outer layer of the multi-layer cable.

2. The mounting bracket according to claim 1, wherein the at least one mounting hole comprises a first set of mounting holes; and
wherein the first set of mounting holes are configured to fit over ground studs on the splice closure such that the mounting bracket can be attached to the splice closure by placing the mounting holes over the ground studs.

3. The mounting bracket according to claim 1, wherein the at least one cable grip protrusion comprises teeth extending transversely with respect to the cable grip protrusion.

4. The mounting bracket according to claim 3, wherein the outer layer comprises metallic strands wrapped around a central cable; and
wherein each individual tooth of the teeth is configured to fit between two adjacent metallic strands.

5. The mounting bracket according to claim 2, wherein the mounting plate comprises a second set of mounting holes configured to fit over ground studs on a second splice closure such that the mounting bracket can be attached to the second splice closure by placing the mounting holes over the ground studs on the second splice closure.

6. The mounting bracket according to claim 5, wherein the mounting plate comprises a second cable grip protrusion extending transversely with respect to the mounting plate;
wherein the second cable grip protrusion aligns with a second edge of a second entry port on a second splice closure;
wherein the second entry port is configured to receive an inner layer of the multi-layer cable.

7. The mounting bracket according to claim 1, wherein the multi-layer cable is an optical ground wire cable.

8. The mounting bracket according to claim 1, wherein the cable grip protrusion is configured to grip the outer layer of the multi-layer cable outboard of the cable splice closure such that the tensile, compressive, twisting, and flexing forces applied on the multi-layer cable are isolated to the mounting bracket, and will not impact the entry of the inner layer of the multi-layer cable into the fiber optic splice closure.

9. The mounting bracket according to claim 1, wherein the diameter of the entry port is defined by a hole in the splice closure.

10. The mounting bracket according to claim 1, wherein the diameter of the entry port is defined by a grommet.

11. The mounting bracket according to claim 1, wherein the diameter of the outer layer of the multi-layer cable is irregular and the diameter of the inner layer of the multi-layer cable is constant.

12. A method of mounting a multi-layer cable to a splice closure, the method comprising:
providing a multi-layer cable comprising an outer layer and an inner layer;
removing a portion of the outer layer from the multi-layer cable at an end or midsection of the multi-layer cable, thereby exposing the inner layer;
providing a mounting bracket comprising:
a mounting plate comprising at least one mounting hole;
at least one cable grip protrusion extending transversely with respect to the mounting plate;
wherein the at least one cable grip protrusion aligns with an edge of an entry port on the splice closure;
wherein a diameter of the entry port is smaller than a diameter of an outer layer of the multi-layer cable;
the method further comprising:
attaching the mounting bracket to the splice closure using the at least one mounting hole;
securing the outer layer of the multi-layer cable to the at least one cable grip protrusion;
inserting the exposed inner layer into the splice closure.

13. The method according to claim 12, further comprising:
providing the at least one cable grip protrusion with teeth;
wherein the outer layer of the multi-layer cable is secured to the at least one cable grip protrusion by aligning the multi-layer cable with the teeth and clamping the outer layer of the multi-layer cable against the teeth.

14. The method according to claim 12, wherein the multi-layer cable is an optical ground wire.

15. The method according to claim 12, wherein the outer layer of the multi-layer cable comprises a plurality of strands wrapped around the inner layer of the multi-layer cable.

16. The method according to claim 12, wherein the diameter of the outer layer of the multi-layer cable is irregular and the diameter of the inner layer of the multi-layer cable is constant.
